(19) United States
(12) Patent Application Publication
(10) Pub. No.: US 2011/0050565 A1
(43) Pub. Date: Mar. 3, 2011

(54) COMPUTER SYSTEM AND CONTROL METHOD THEREOF

(75) Inventor: Wan-seok KO, Gyeonggi-do (KR)

(73) Assignee: SAMSUNG ELECTRONICS CO., LTD., Gyeonggi-Do (KR)

(21) Appl. No.: 12/830,597

(22) Filed: Jul. 6, 2010

(30) Foreign Application Priority Data
Aug. 25, 2009 (KR) 10-2009-0078637

(51) Int. Cl. G09G 5/00

(52) U.S. Cl. 345/156

(57) ABSTRACT

A computer system and a method for controlling the same, even while the case of the electronic device is closed by making the device capable of using various functions by a simple and convenient input method. The computer system comprises at least one device unit; a housing in which the device unit(s) is provided; a motion sensing unit configured to sense a user motion taken at an outer side of the housing; and a controller configured to control the device unit(s) to perform an operation corresponding to the user motion sensed by the motion sensing unit.

### CLAIM OF PRIORITY

This application claims priority from Korean Patent Application No. 10-2009-0078637, filed on Aug. 25, 2009 in the Korean Intellectual Property Office, the disclosure of which is incorporated herein by reference in its entirety.

### BACKGROUND OF THE INVENTION

1. Field of the Invention

The present invention relates to apparatuses and methods consistent with a computer system and a method for controlling the same. More particularly, the present invention relates to a computer system and a method for controlling the same, capable of using various functions by a simple and convenient input method.

2. Description of the Related Art

A conventional computer system, such as a laptop computer, typically includes a main body having a keyboard and the like and a display unit such as a LCD configured to be opened and closed with respect to the main body.

In such a conventional computer system, when the display unit is closed, user interfaces such as the keyboard and the LCD are unable to operate normally. Accordingly, it is necessary to open the display unit to normally use the computer system.

However, although the display unit is closed, there are times where a user may want to use a function of the computer system as desired. By such a conventional method, it is difficult to solve such a problem.

Furthermore, even when the display unit is opened, a user may feel some difficulty or inconvenience in using the user interfaces such as the keyboard and the LCD. By the conventional method, there is still no solution to overcome such difficulty or inconvenience.

### SUMMARY OF THE INVENTION

Accordingly, an exemplary aspect of the present invention is to provide a computer system and a method for controlling the same, that is capable of using various functions by a simple and convenient input method without being restricted to a specific state of the computer system, such as a case that a display unit is closed.

According to an exemplary aspect of the present invention, there is a computer system comprising at least one device unit; a housing in which the device unit(s) is provided; a motion sensing unit configured to sense a user motion taken at an outer side of the housing; and a controller configured to control the device unit(s) to perform an operation corresponding to the user motion sensed by the motion sensing unit.

The housing preferably comprises a cover that is openable with respect to the at least one device unit, and the controller determines an operation corresponding to the sensed user motion when the cover is closed.

The at least one device unit comprises at least one of a user input unit and a display unit.

The motion sensing unit senses a user motion taken at an outer side of the cover.

The motion sensing unit preferably comprises a conductive sensor provided at an inner side of the housing, the sensor being separated therefrom, and the controller recognizes the user motion, for example, according to a variation of a capacitance value between the housing and the sensor.

The sensor is provided in a plural number on a planar surface in parallel with the housing.

The controller recognizes the user motion according to whether or not the variation of the capacitance value is continuous.

The at least one device unit preferably comprises a display unit having a panel shape, the display unit being arranged at an inner side of the housing, and the motion sensing unit is arranged preferably between the housing and the display unit.

The controller selects one of a plurality of predetermined shapes that is similar to the user motion and controls the at least one device unit to perform an operation corresponding to the selected shape.

According to another exemplary aspect of the present invention, there is a method of controlling a computer system, the method preferably comprising: determining an operation of at least one device unit corresponding to a user motion taken at an outer side of a housing, the at least one device unit being provided in the housing; and controlling the at least one device unit to perform the operation corresponding to the user motion.

The housing unit comprises a cover that is openable and closable with respect to the at least one device unit, and the determining of an operation comprises determining an operation of the at least one device unit corresponding to the user motion when the cover is closed.

The at least one device unit comprises at least one of a user input unit and a display unit.

The determining of an operation comprises recognizing the user motion according to a variation of a capacitance value between the housing and a conductive sensor provided at an inner side of the housing, the sensor being separated therefrom.

The determining of an operation further comprises recognizing the user motion according to whether or not the variation of the capacitance value is continuous.

The determining of an operation also comprises selecting one of a plurality of predetermined shapes that is similar to the user motion, and the controlling of the at least one device unit comprises controlling the at least one device unit to perform an operation corresponding to the selected shape.

### BRIEF DESCRIPTION OF THE DRAWINGS

The above and/or other exemplary aspects of the present invention will become apparent and more readily appreciated from the following description of the exemplary embodiments, taken in conjunction with the accompanying drawings, in which:

FIGS. 1 and 2 are perspective views showing a computer system in accordance with an exemplary embodiment of the present invention;

FIG. 3 is a block diagram showing a structure of the computer system in accordance with an exemplary embodiment of the present invention;

FIG. 4 shows a motion sensing unit and a controller in accordance with an exemplary embodiment of the present invention;

FIG. 5 shows in detail the motion sensing unit in accordance with an exemplary embodiment of the present invention;

FIG. 6 is a flowchart showing an exemplary operation of the computer system in accordance with an exemplary embodiment of the present invention; and

FIG. 7 is a detailed flowchart showing an exemplary operation of the computer system in accordance with an exemplary embodiment of the present invention.

### DETAILED DESCRIPTION

Below, exemplary embodiments of the present invention will now be described in detail with reference to accompanying drawings so as to be easily realized by a person having ordinary knowledge in the art. The present invention may be embodied in various forms without being limited to or by the examples set forth herein.

Descriptions of well-known structures and constructions may be omitted for clarity, when their inclusion could obscure appreciation of the subject matter of the present invention by a person of ordinary skill in the art. Like reference numerals refer to like elements throughout.

Referring now to the accompanying drawings, exemplary embodiments of the present invention are as follows.

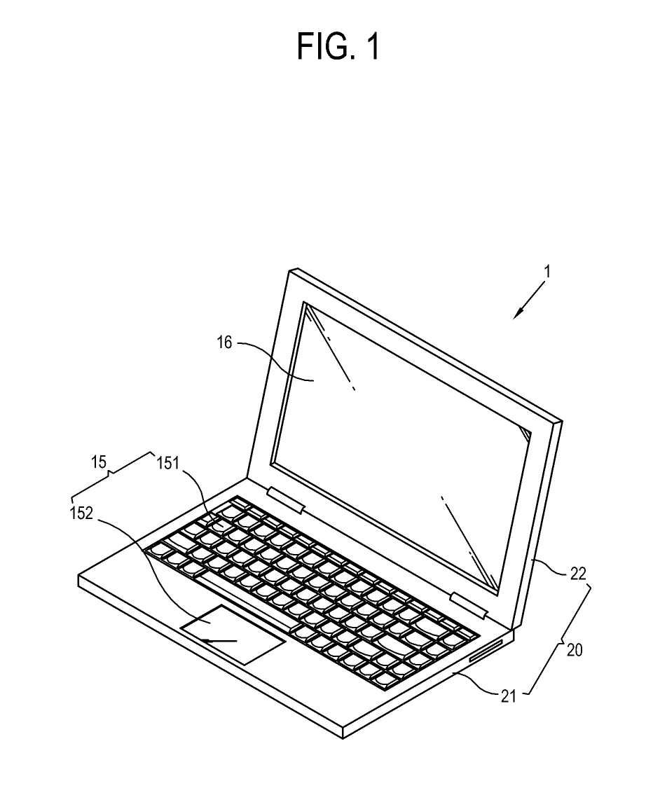

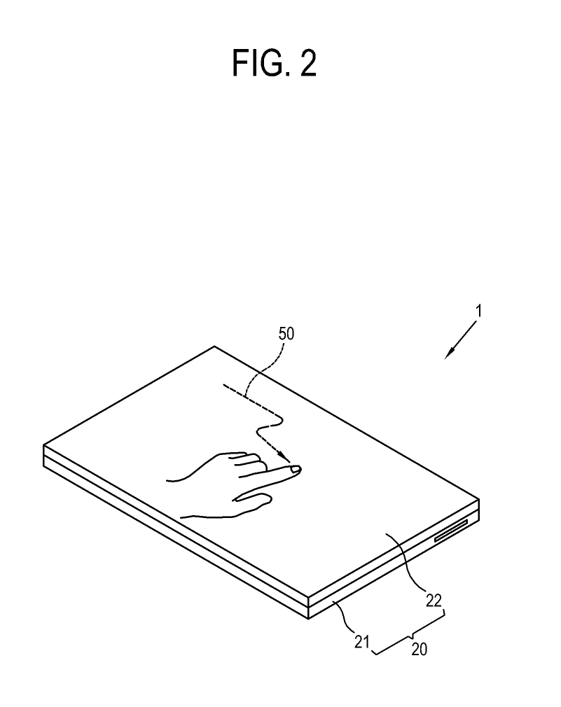

FIGS. 1 and 2 are perspective views showing a computer system 1 in accordance with an exemplary embodiment of the present invention. Specifically, FIGS. 1 and 2 show an opened state and a closed state, respectively, of the computer system 1.

As shown in FIGS. 1 and 2, in accordance with the present exemplary embodiment, the computer system 1 may include a user input unit 15 which receives a user's input; and a display unit 16 which displays an operation state of the computer system 1. The user input unit 15 may comprise a keyboard 151 and a pointing unit 152. In accordance with the present embodiment, the display unit 16 may include a liquid crystal display (LCD. However, any type of thin-film technology screen may also be used. In addition, the display unit could also comprise a touch screen.

In accordance with the present exemplary embodiment, the computer system 1 may include a housing 20, and the housing 20 may include a main body 21 in which the user input unit 15 is provided; and a cover 22 in which the display unit is provided. In accordance with the present exemplary embodiment, the cover 22 may be pivotable with respect to the main body 21 by being hinged therewith.

FIG. 1 shows a state where the cover 22 is opened with respect to the main body 21, and FIG. 2 shows a state where the cover 22 is closed with respect to the main body 21.

As shown in FIG. 1, when the cover 22 is opened, a user may freely use a keyboard 151 and a pointing unit 152 and watch a screen to be displayed on the display unit 16 without any restriction. In contrast, as shown in FIG. 2, when the cover 22 is closed, a user is physically restricted in using the keyboard 151 and the pointing unit 152 and from watching the screen to be displayed on the display unit 16.

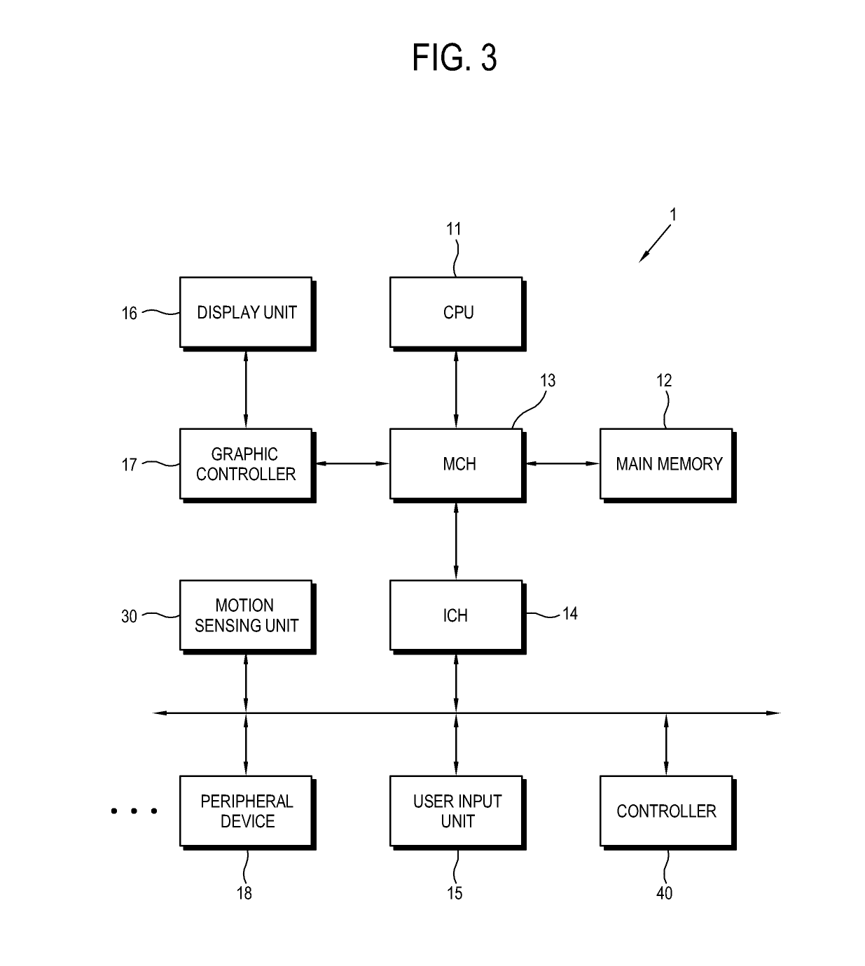

The computer system 1 of the present exemplary embodiment will now be described in more detail with reference to FIG. 3. FIG. 3 is a block diagram showing a structure of the computer system 1 in accordance with the embodiment of the present invention.

As shown in FIG. 3, the computer system 1 may include, for example, a central processing unit (CPU) 11, a main memory 12, a memory controller hub (MCH) 13, an I/O controller hub (ICH) 14, a graphic controller 17, and a peripheral device 18.

The CPU 11 may control general operations of the computer system 1 and activate a computer program loaded in the main memory 12. To activate such a computer program, the CPU 11 may communicate with the MCH 13 and ICH 14 to control the MCH 13 and ICH 14.

The main memory 12 may temporarily store not only the computer program activated by the CPU 11, but also data related to the operation and performance of the CPU 11. The main memory 12 may be embodied as a volatile memory, e.g., a double-data-rate synchronous dynamic random access memory (DDR SDRAM), or the like.

The graphic controller 17 may process graphic data of an image displayed on the display unit 16. The peripheral device 18 may include various hardware such as a hard disk drive, a flash memory, a CD-ROM, a DVD-ROM, a USB drive, a Bluetooth adapter, a modem, a network adaptor, a sound card, a speaker, a microphone, a tablet, a touch screen and the like.

The MCH 13 may interface the main memory 12 with other elements such as the CPU 11 for reading and writing of data. The ICH 14 may interface the CPU 11 with the peripheral device 18 for communication. In accordance with the present embodiment, a computer program activated by the CPU may include a BIOS, an operating system, and an application. In accordance with the present embodiment, the BIOS may be stored in a nonvolatile memory (not shown), e.g., a BIOS ROM. The operating system and the application may be stored in a hard disk drive, for example. In accordance with the present embodiment, the CPU 11, the main memory 12, the MCH 13, the ICH 14, the user input unit 15, the display unit 16, the graphic controller 17, and the peripheral device 18 may be some examples of a device unit.

As shown in FIGS. 2 and 3, in accordance with the present exemplary embodiment, the computer system 1 may further include a motion sensing unit 30, which senses a user motion 50 taken at an outer side of the housing 20; and a controller 40 which controls the device unit, e.g., the peripheral device 18, to perform an operation corresponding to the user motion 50 sensed by the motion sensing unit 30. Accordingly, although use of the keyboard 151 and the pointing unit 152 or watch a screen displayed on the display unit 16 is limited because the cover 22 is closed, it is possible to perform a corresponding operation by making the user motion 50 at the outer side of the housing 20. As a result, the user's convenience can be improved in the present exemplary embodiment.

Furthermore, even though the cover 22 is opened as shown in FIG. 1, the controller 40 may control the device unit, e.g., the peripheral device 18, to perform an operation corresponding to a user motion sensed by the motion sensing unit 30. In this particular case, depending on whether the door is opened or closed, the operations corresponding to the same user motions may be identical to or different from each other.

As such, although in FIG. 1 the cover 22 is opened, when it is difficult to use typical input units such as the keyboard 151 and the pointing unit 152 or when a user does not prefer the typical input units, it is possible to improve the user's convenience by performing an operation corresponding to a user motion taken at the outer side of the housing 20.

In accordance with the present exemplary embodiment, the user motion 50 (such as shown in FIG. 2) taken at the outer side of the housing 20 may include a contact motion wherein a user body (or stylus, etc.) is brought into contact with the housing 20; and a noncontact motion wherein a user motion is taken separately from the housing 20 at a predetermined interval.

As shown in FIG. 2, in accordance with the present exemplary embodiment, the user motion 50 may be taken at the outer side of the cover 22, and the motion sensing unit 30 may be configured to sense the user motion 50. Since the outer side of the cover 22 is easier for a user to access as compared with other sides based on the structure of the computer system 1, a user may use the computer system 1 more easily.

However, as shown in FIG. 2, the user motion 50 taken at the outer side of the cover 22 is merely an example of the present exemplary embodiment. The present invention is applicable to any outer side of the housing 20. For example, the present invention is applicable to a front side, a lateral side, a rear side, and/or a bottom side of the main body 21.

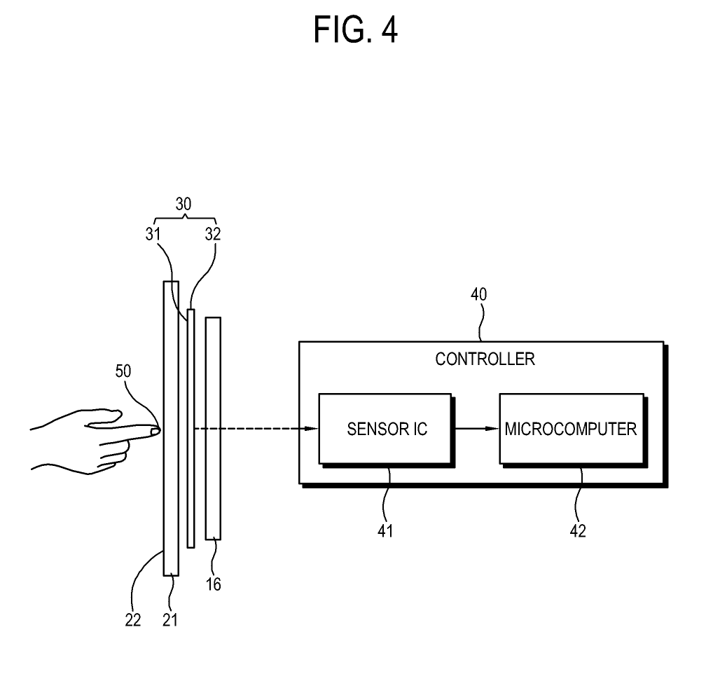

The motion sensing unit 30 and the controller 40 in accordance with the present embodiment will now be described in more detail with reference to FIG. 4. FIG. 4 is a reference view for describing the motion sensing unit 30 and the controller 40. In FIG. 4, a side-section of the display unit 16 and the cover 22 are schematically shown. With respect to the cover 22, a user's side is referred to as “outer side” of the cover 22 and a display unit's side is referred to as “inner side” of the cover 22 in FIG. 4.

As shown in FIG. 4, the motion sensing unit 30 of the present exemplary embodiment may be arranged at an inner side of the cover 22. Accordingly, since the motion sensing unit 30 is not exposed to an outside of the cover 22, it is possible to more adequately improve an outer appearance of the computer system 1.

Moreover, as shown in FIG. 4, the motion sensing unit 30 of the present exemplary embodiment may be arranged (as in this example) between the cover 22 and the display unit 16. As described above, such a structure can adequately sense a user motion 50 made around the outer cover 22 which a user can easily access. Furthermore, such a structure allows the motion sensing unit 30 not to act as a viewing obstacle when the user watches the display unit 16 of the computer.

As shown in FIG. 4, the motion sensing unit 30 of the present exemplary embodiment may include, for example, a sensor 31 which senses the user motion 50; and a panel-shaped plate 32 in which the sensor 31 is provided. In accordance with the present exemplary embodiment, the sensor 31 may comprise a conductive element arranged in an inner side of the cover 22, the element being separated therefrom at a predetermined interval.

The controller 40 of the present exemplary embodiment may monitor a variation of a capacitance value between the cover 22 and the sensor 31 caused by the user motion 50, and recognize the different user motions 50 according to the variation of the capacitance value. As such, by using such a motion recognizing method shown in FIG. 4, the motion sensing unit 30 may be arranged at the inner side of the housing 20 instead of being exposed to the outside thereof.

As shown in FIG. 4, the controller 40 of the present embodiment may include a sensor IC 41 for recognizing the user motion 50 according to the variation of the capacitance value between the cover 22 and the sensor 31; and a microcomputer 42 programmed for controlling the device unit according to the user motion 50 recognized by the sensor IC 41.

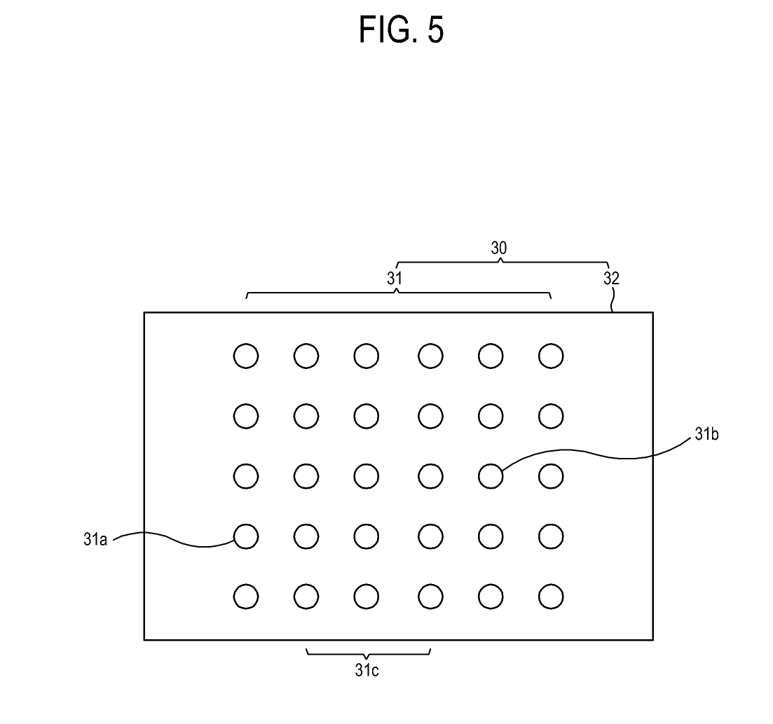

FIG. 5 shows in detail the motion sensing unit 30 in accordance with the exemplary embodiment of the present invention, which viewed from the user shown in FIG. 4. As shown in FIG. 5, the sensor 31 is preferably plural in number and arranged in the plate 32. Each sensor 31 may be used to measure a variation of the capacitance value at a predetermined region in the cover 22. As such, by providing on a planar surface a plurality of sensing elements having a limited sensing area, it is possible to more widely sense the user motion 50.

The sensors 31 of the present exemplary embodiment, as shown in FIG. 5, may be arranged in a matrix form. The number and configuration of the sensors shown in FIG. 5 is merely an example and the claimed invention is not limited to or by the present exemplary embodiment. Alternatively, the sensors 31 of the present exemplary embodiment may be provided on a surface of the plate 32, or can be inserted into or can extend through the plate 32. Different motions sensed by the sensors can control different commands. Thus, the computer, or other electronic device, can be accessed with the cover still closed.

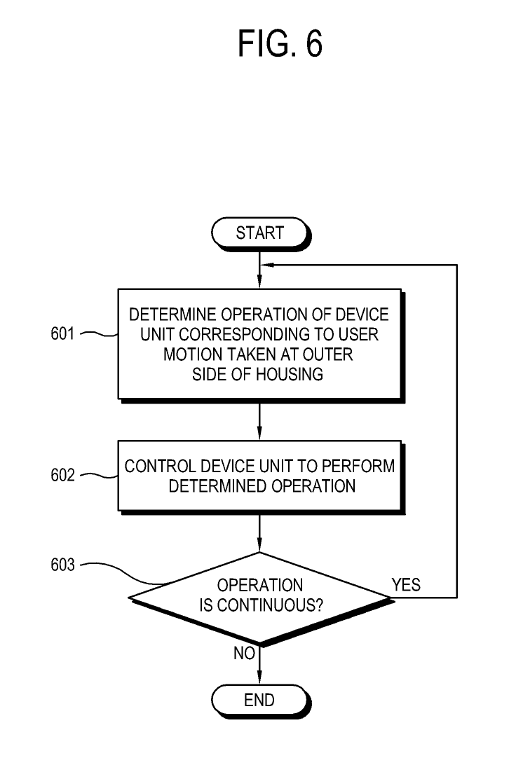

FIG. 6 is a flowchart showing an operation of the controller 40 in accordance with an exemplary embodiment of the present invention.

First, at step (601), the controller 40 of the present exemplary embodiment may determine an operation of the device unit corresponding to a specific user motion 50 taken at the outer side of the housing 20, wherein the user motion 50 being sensed through the motion sensor 30. In the process at step (601), the controller 40 of the present exemplary embodiment may recognize the user motion 50 taken at the outer side of the housing 20 and determine the particular operation of the device unit corresponding to the recognized user motion 50.

Then, at step (602), the controller 40 of the present embodiment may control a corresponding device unit to perform the determined operation. Next, the controller 40 of the present embodiment may check whether or not the operation is continuously performed; and carry out the processes 601 and 602, if the operation is continuously performed, or complete the operation, if the operation is not continuously performed (603).

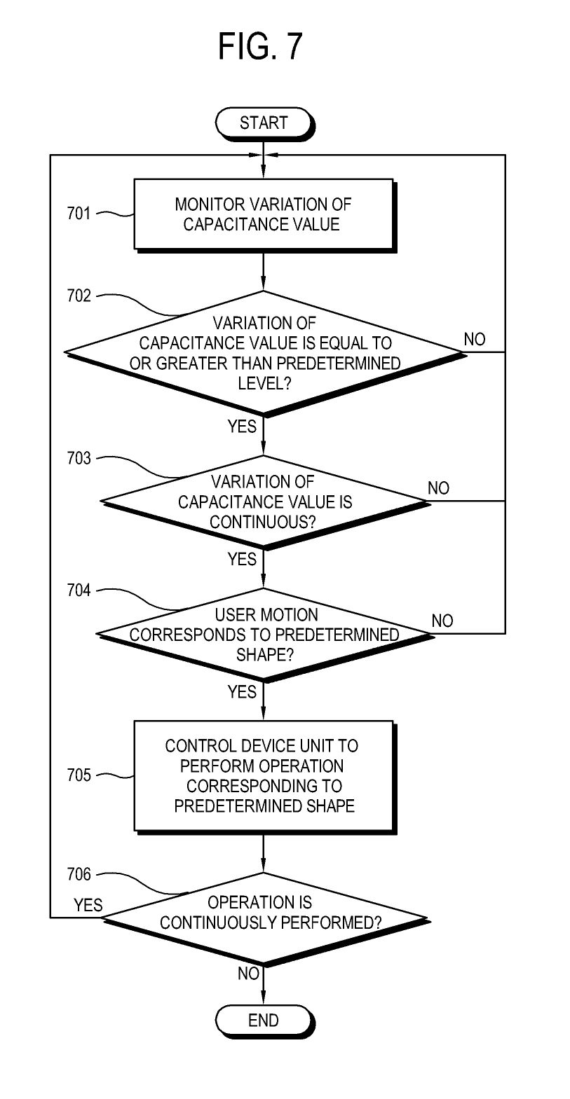

FIG. 7 is a detailed flowchart showing an operation of the controller 40 in accordance with an exemplary embodiment of the present invention.

First, at step (701), the controller 40 of the present exemplary embodiment may monitor a variation of a capacitance value caused by the user motion 50 taken at an outer side of the housing 20 through the sensors 31 shown in FIGS. 4 and 5.

Then, the controller 40 of the present exemplary embodiment may check whether or not the variation of the capacitance value is equal to or greater than a predetermined level; and determine whether the variation is a noise, if the variation is less than the predetermined level, and to return to the process 701. Accordingly, by filtering undesired motions at the maximum, it is possible to improve the reliability in recognition.

If it is determined at step (702) that the variation is equal to or greater than the predetermined level, then at step (703) the controller 40 of the present exemplary embodiment may check whether or not the variation of the capacitance value is continuous. For example, as shown in FIG. 5, the controller 40 of the present exemplary embodiment may determine that the variation of the capacitance value is a noise, when although a first and a second sensor 31a and 31b sense the variation in a difference of a predetermined time interval, a third sensor 31c as any one of the sensors arranged at three lines sense no variation of the capacitance value. Accordingly, by filtering discontinuous motions at the maximum, it is possible to improve the reliability in recognition.

By referring to FIG. 7 again, if it is determined at (703) that the variation of the capacitance value is not continuous, then at (702) the controller 40 of the present may return to step (701). The controller 40 of the present exemplary embodiment at step (704) may check whether or not the recognized user motion 50 corresponds to a predetermined shape.

In accordance with the present exemplary embodiment, the predetermined shape is not limited to a specific shape. The predetermined shape may be easily depicted by a user and easily sensed by the sensor. The following Table 1 shows some various shapes of the present exemplary embodiment and their associated operation.

TABLE 1

| Shape | Operation |
|---|---|
| 0 | Power off -> Power on |
| a | Audio is played back |
| b | Battery residual amount is displayed |
| C | Current time is displayed |
| L | System is locked |
| X | System is ended |

As shown in Table 1, the shape of the present embodiment may be one of simple alphabets such as “0,” “a,” and or the like. However, the shapes of the present embodiment shown in table 1 are merely examples. Alternatively, the shape of the present exemplary embodiment may be embodied as one of various other symbols, geometric motions, lines, figures, and the like.

In step (704) shown in FIG. 7, if it is determined that the recognized user motion 50 does not correspond to the predetermined shape, the controller 40 of the present exemplary embodiment may return to the process 701. If it is determined that the recognized user motion 50 corresponds to a predetermined shape, the controller 40 of the present exemplary embodiment may control the device unit to perform an operation corresponding to the shape (705).

For example, if the user motion 50, recognized in a power-off state (or a sleep mode), corresponds to the shape “0” shown in Table 1, the controller 40 of the present embodiment may control the device unit to turn the power on. In this case, if a booting of the operating system is completed, the controller 40 of the present embodiment may additionally inform a user that the booting is completed through an external LED or a speaker. As another example, if the user motion 50 corresponds to “a,” “b,” or the like shown in table 1, the controller 40 of the present embodiment may play back the audio or display the battery residual amount through the external LED. However, the operations of the device unit shown in Table 1 are merely examples. The operations of the device unit may be embodied as various other operations that can be provided by the computer system 1. For example, if the notebook computer has a camera module, a motion on the external case of the computer may activate the recording function of the camera, or snap a picture.

The shapes of user motions of the present exemplary embodiment and corresponding operations of the device unit may be stored in a hard disk drive or the like. They may be predetermined as the default and, then, changed or re-determined by a user.

At step (705), the controller 40 of the may check whether or not the operation is continuously carried out; and re-perform the processes 701 to 705, if the operation is continuously carried out, or at step (706) complete the operation, if the operation is not continuously carried out.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

For example, in the present exemplary embodiment, a laptop computer where the cover 22 having the display unit 16 is opened or closed is provided as the computer system 1. However, the computer system in accordance with the embodiment of the present invention is not limited to the laptop computer, and could just as easily comprise a PDA, mobile telephone, tablet computer, etc. Alternatively, the computer system is applicable to the case where another element having no display unit 16 is opened or closed.

The above-described methods according to the present invention can be realized in hardware or as software or computer code that can be stored in a recording medium such as a CD ROM, a RAM, thumbnail drive, a floppy disk, a flash storage, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

What is claimed is:

1. A computer system comprising:
at least one device unit;
a housing in which the at least one device unit is arranged;
a motion sensing unit configured to sense a user motion along an outer side of the housing; and
a controller configured to control the at least one device unit to perform an operation associated with the user motion sensed by the motion sensing unit.

2. The system of claim 1, wherein the housing comprises a cover that has an open position and a closed position with respect to the at least one device unit, and
wherein the controller determines an operation corresponding to a particular sensed user motion when the cover is closed.

3. The system of claim 2, wherein the at least one device unit comprises at least one of a user input unit and a display unit.

4. The system of claim 2, wherein the motion sensing unit senses a user motion made along an outer side of the cover.

5. The system of claim 3, wherein the motion sensing unit senses a user motion made along an outer side of the cover.

6. The system of claim 1, wherein the motion sensing unit comprises a conductive sensor arranged in an inner side of the housing, the sensor being separated therefrom, and
wherein the controller recognizes the user motion according to a variation of a capacitance value between the housing and the sensor.

7. The system of claim 6, wherein the sensor is arranged in a plurality thereof on a planar surface in parallel with the housing.

8. The system of claim 6, wherein the controller recognizes a particular user motion according to whether or not the variation of the capacitance value is continuous.

9. The system of claim 7, wherein the controller recognizes a particular user motion according to whether or not the variation of the capacitance value is continuous.

10. The system of claim 1, wherein the at least one device unit comprises a display unit having a panel shape, the display unit being arranged at the inner side of the housing, and
wherein the motion sensing unit is arranged between the housing and the display unit.

11. The system of claim 10, wherein the housing comprises a cover that has an open position and a closed position with respect to the at least one device unit, and
wherein the motion sensing unit is arranged between the housing and the display unit when the cover is in a closed position.

12. The system of claim 1, wherein the controller selects one of a plurality of predetermined shapes that corresponds to a shape of the user motion and controls the at least one device unit to perform an operation corresponding to the selected shape.

13. A method of controlling a computer system, the method comprising:
determining an operation of at least one device unit corresponding to a user motion made along an outer side of a housing, the at least one device unit being provided in the housing; and
controlling the at least one device unit to perform the operation corresponding to the user motion.

14. The method of claim 13, wherein the housing unit comprises a cover that has an open position and a closed position with respect to the at least one device unit, and
wherein the determining of an operation comprises determining an operation of the at least one device unit corresponding to a particular sensed user motion when the cover is in a closed position.

15. The system of claim 14, wherein the at least one device unit comprises at least one of a user input unit and a display unit.

16. The method of claim 13, wherein the determining of an operation comprises recognizing the user motion according to a variation of a capacitance value between the housing and a conductive sensor provided at an inner side of the housing, the sensor being separated therefrom.

17. The method of claim 16, wherein the determining of an operation further comprises recognizing the user motion according to whether or not the variation of the capacitance value is continuous.

18. The method of claim 13, wherein the determining of an operation comprises selecting one of a plurality of predetermined shapes that corresponds to a shape of the user motion, and
wherein the controlling of the at least one device unit comprises controlling the at least one device unit to perform an operation corresponding to the selected shape.
